(19) United States
(12) Patent Application Publication
(10) Pub. No.: US 2005/0170319 A1
(43) Pub. Date: Aug. 4, 2005

(54) Method of speaking instruction

(76) Inventors: Scott Alberts, Burbank, CA (US); Roger Love, Burbank, CA (US)

Correspondence Address: JAMES E. BRUNTON, ESQ., P. O. BOX 29000, GLENDALE, CA, 91209, US

(21) Appl. No.: 10/770,272

(22) Filed: Feb. 3, 2004

(51) Int. Cl. G09B 19/04

(52) U.S. Cl. 434/185

(57) ABSTRACT

A method for teaching an individual to speak correctly using novel visual displays and supporting descriptive material. The visual display comprises a string of discreet visual segments illustrating volume, pace, pitch, melody and tone that guide the individual in creating specific sounds and speech patterns. The visual displays can be published in a book or pamphlet from or in electronic media such as CD, CD-Rom, DVD, or video.

### BACKGROUND OF THE INVENTION

1. Field of the Invention

The invention relates generally to instructional speaking. More particularly, the invention concerns a graphical method for teaching an individual to speak correctly using a novel visual display. The visual display which comprises a string of discreet visual segments that are displayed guides the individual in creating specific sounds and speech patterns. The visual display can be published in a book, pamphlet, or electronic media such as CD, CD-Rom, DVD or video.

2. Description of the Prior Art

Speaking instruction with professional experts in a classroom environment has been provided in the past in schools and seminars. However, such instruction is typically quite expensive and is generally available in limited geographic locations such as in metropolitan areas. Additionally, such instruction often requires that a student travel to a classroom or to a seminar location thereby making the instruction inconvenient and time consuming.

In the past, instruction by individuals, schools, companies and other organizations have provided, in various formats, expert advice and techniques for speaking. Similarly, many books and other publications have addressed speaking techniques and systems for improving speech. However, these systems are almost entirely word based solutions in which the student is primarily instructed to use or not to use specific words. Completely absent in most prior art methods which are the important considerations of melody, tone, pitch, specific pace, and volume. As will be discussed in the paragraphs which follow, precise combinations of these aspects are specifically considered in the methods of the present invention. In one method of the present invention, melody, that is the movement of low and high pitches, is represented by a scale which goes from less melody-monotone-to more melody as for example, in a Mozart Concerto. Tone is depicted on a scale from airy-Marilyn Monroe type tone, all the way to an edgy sound. A graphical representation of all the way to an edgy sound, pitch tells the student what part of the voice, range to adapt, for example, deep like James Earl Jones or high in the manner of Michael Jackson and Mickey Mouse.

The methods of the present invention overcome many of the drawbacks of the prior art systems and provide a highly versatile, multifaceted teaching system that is easy to use and is very effective in teaching individuals how to speak effectively. The teaching systems of the invention is uniquely made available in several instructional formats. For example, the visual cues used in the instructional methods can be made available on compact disc, for display on a computer, or on video cassettes, or alternatively on DVD's for display on a television. Similarly, the methods can be made available on a server for display on remote computers that are connected to receive data from the server. Alternatively, a published version of the visual cues in a pamphlet or book format can be provided.

### BRIEF DESCRIPTION OF THE DRAWINGS

FIG. 1 is a graphical representation of the volume aspect of speech indicating to the student how loud or soft to speak.

FIG. 2 is a graphical representation or visual display of the pace aspect of speech indicating to the student how fast or slow to speak.

FIG. 3 is a graphical representation of the pitch aspect of speech indicating to the student where to speak in the high to low sections of the pitch range of the human voice.

FIG. 4 is a graphical representation of the melody aspect of speech indicating to the student when words are to be spoken with more or less melody.

FIG. 5 is a graphical representation of the tone aspect of speech indicating to the student when to use more or less airiness and edginess in the voice.

### DESCRIPTION OF THE INVENTION

Referring to the drawings, it is to be observed that various aspects of human speech are graphically represented in five categories, namely volume, pitch, tone, pace and melody. In accordance with one form of the method of the invention, these graphical representations are used to instruct the student as to precisely what level of each of these aspects is to be adopted in a given situation. Accompanying text is also used to further explain the speech choices.

As will be discussed in greater detail in the paragraphs which follow, in accordance with the teaching methods of the invention, the student is provided with some or all of the graphical representations illustrated in the previously described drawings. With the graphical representations in hand, the student simply follows along with the specific sound suggestions provided and creates the perfect speaking voice for each unique situation. Examples of these specific sound suggestions are hereinafter discussed as they pertain to preparing the student for a specific speaking requirement.

By way of introduction to the various graphical representations, an individual preparing for a job interview may be advised as follows: “As you look over the resume that you normally send out, you see the long list of credits and accomplishments you have achieved so far on your corporate journey. Most people in person however, don't exactly live up to the incredible image of themselves on paper. Most of us are a little shorter than expected or smaller or slightly less good looking. Irregardless of what it says on your Resume, the real you should be a million times better in person. Following along with the following tips will greatly increase your chances of actually getting the job you want.”

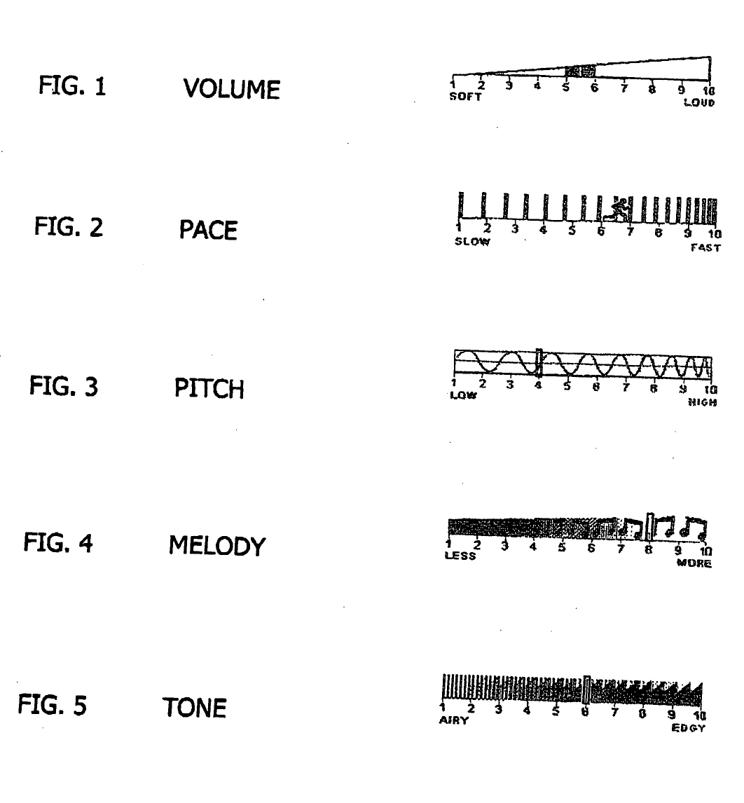

With regard to volume, the student is handed the graphical representation of FIG. 1 and is advised as follows:

“It's very important that the interviewer realize your strength and strong energy within the first few moments. One easy way to do that is with little extra volume. This is not the time to be introverted and shy. No matter what the job is, you don't want to come across as the brooding silent type. Remember, that every word you say is important. No matter what your answer is to a particular question no matter what the content of the conversation is one rule holds absolute . . . he needs to easily hear whatever you have to say. Don't force him to say ‘What?’ or ‘Could you repeat?’ Your volume goal is to find the level that is solid, vibrant, commanding and confident without being forceful or overly aggressive. Like the Beach Boys said, it's all about good vibrations. So let your voice fill the entire room with great sound. Normally, your volume will be in the mid range (4 to 5), however when particular emphasis is appropriate, the volume should be in the upper range, as for example, in the 6 to 7 range.”

With regard to pace, the student will be referred to the graphical representation of FIG. 2 and will be advised as follows:

“I am very interested in you sounding like your brain works fast. Having a fast brain is like a computer that does anything you want at the instant you give it a command. One way to create this intelligence aura is to speak a little bit on the faster side when you respond to a question. I don't mean answer without thinking. I want you to take a few seconds and formulate the beginning of the answer in your mind. Then, when you do open your mouth to speak, let the words roll out a tiny bit faster than normal. This will help you sound more confident and secure. Don't think that I'm looking for a runaway train sound. I am simply asking you to keep the pace lively and move forward with ease and purpose. It's important not to sound like you're meandering around in the dark looking for a light switch, afraid of bumping into any furniture.

With regard to pitch, the student is provided with a graphical representation of pitch as illustrated in 3 and is advised as follows:

“I want you to stay in the lower third of your comfortable vocal range. The idea here is to sound like you are not easily overexcited and nervous. When something scary suddenly happens, most people raise the pitch of their voices. So, if you repeatedly speak too high, the interviewer will falsely get the impression that you are scared. It's better to broadcast the idea that you are fearless, and not easily shaken and rarely nervous.”

As to melody, the student is handed of a graphical representation of melody, such as shown in FIG. 4 and is advised as follows:

“Even though I have suggested that you stay on the lower third of the pitch spectrum. I'm still looking for a great deal of fabulous melody. I want you to sound like you have a terrific sense of humor and passion, melody will help with that.

I want you to sound like a positive, can-do, let me run with the ball kind of person. Listen to the great news anchors, they are able to tell you horribly sad and negative headlines and still make you like the messenger. They have learned some basic secrets to taking negative and making it sound better. One easy way is through melody. Most of us, when we are sad get softer and sound very monotonous, as if we are simply too sad to speak up with any real energy. We become more introverted and less vocally alive. This is not the impression we want to give during an interview. Having the voice move up and down like a great song melody is music to the listener's ears. I want them to think of replacing the piped in music at the office with your beautiful voice. When you speak, let it be as if they've just heard their favorite song and make them want to hear it again.”

As to airiness, the student is provided with a graphical representation such as shown in FIG. 5 and is counseled as follows:

“No matter what the interview is for, do not make your voice too airy. Even if you are interviewing for a job as phone sex therapist, it's better for you to sound strong, powerful, confident, less airy and then when you decide to, you can show any character voice you think would work on their specific clientele. Remember, that the airy sounding voice is usually associated with a certain amount of low intelligence. How many ridiculous blond jokes have we heard over the years? And what voice do you think the stereotypical blond girl in the joke would have . . . airy of course. So stay away from the airy end of the sound spectrum and make your voice vibrant and edgy. By doing this, you are perceived as being strong and intelligent. Remember, you can have plenty of passion in your voice without going into bedroom-airy mode.”

In concluding the teaching session and in accordance with one form of the method of the invention, the student is advised as follows: “Try to remember one thing in every interview room. There is an object that is one of a kind, unique, irreplaceable, beautiful and priceless YOU. By playing around with the vocal sound ideas we have offered, you will most certainly present yourself as the “star” you are supposed to be. By using your voice as a new and important influence tool, you have a much better chance of success.”

It is to be understood that in preparing the student for other speaking requirements, graphical representations showing different degrees of volume, pace, pitch, melody and tone from these shown in the drawings may be used. Similarly, different suggestions which relate to the particular speaking requirement may be provided to the student. As previously mentioned, the format for these presentations may be in written form, video form, or in the form of compac disc's and the like.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

1. A teaching method for teaching an individual to speak correctly and effectively by providing to the individual visual displays comprising a plurality of graphical representations for guiding the individual in creating specific sounds and speech patterns.

2. The method as defined in claim 1 in which said visual displays are provided in written form.

3. The method as defined in claim 1 in which said visual displays are provided in video form.

4. The method as defined in claim 1 in which said visual displays are provided in the form of a compact disc.

5. The method as defined in claim 1 in which said visual displays provided to the individual includes a graphical representation of volume indicating to the individual how loud or soft to speak.

6. The method as defined in claim 5 in which said visual displays provided to the individual further include a graphical representation of pace indicating to the individual how fast or slow to speak.

7. The method as defined in claim 6 in which said visual displays provided to the individual further include a graphical representation of pitch indicating to the individual where to speak in the high to low sections of the pitch range of the human voice.

8. The method as defined in claim 7 in which said visual displays provided to the individual further include a graphical representation indicting to the individual when words are to be spoken with more or less melody.

9. The method as defined in claim 8 in which said visual displays provided to the individual further include a graphical representation of tone indicating to the student when to use more or less airiness and edginess in the voice.

10. A teaching method for teaching an individual to speak correctly by providing to the individual visual displays comprising a plurality of graphical representations for guiding the individual in creating specific sounds and speech patterns, said graphical representations provided to the individual including a graphical representation of volume indicating to the individual how loud or soft to speak and a graphical representation of pace indicating to the individual how fast or slow to speak.

11. The teaching method as defined in claim 10 in which said graphical representations are provided to the student in written form.

12. The teaching method as defined in claim 10 in which said graphical representations are provided to the student in electronic form.

13. The method as defined in claim 10 in which said visual displays provided to the individual further include a graphical representation of pitch indicating to the individual where to speak in the high to low sections of the pitch of the human voice.

14. The method as defined in claim 13 in which said visual displays provided to the individual further include a graphical representation indicting to the individual when words are to be spoken with more or less melody.

15. The method as defined in claim 14 in which said visual displays provided to the individual further include a graphical representation of tone indicating to the student when to use more or less airiness and edginess in the voice.

16. A teaching method for teaching an individual to speak correctly by providing to the individual visual displays comprising a plurality of graphical representations for guiding the individual in creating specific sounds and speech patterns, said graphical representations provided to the individual including a graphical representation of volume indicating to the individual how loud or soft to speak; a graphical representation of pace indicating to the individual how fast or slow to speak; and a graphical representation of pitch indicating to the individual where to speak in the high to low sections of the pitch of the human voice.

17. The teaching method as defined in claim 16 in which said graphical representations are provided to the student in written form.

18. The teaching method as defined in claim 16 in which said graphical representations are provided to the student in electronic form.

19. The method as defined in claim 16 in which said visual displays provided to the individual further include a graphical representation indicting to the individual when words are to be spoken with more or less melody.

20. The method as defined in claim 19 in which said visual displays provided to the individual further include a graphical representation of tone indicating to the student when to use more or less airiness in the voice.
